(19) United States
(12) Patent Application Publication
(10) Pub. No.: US 2001/0056422 A1
(43) Pub. Date: Dec. 27, 2001

(54) Database access system

(76) Inventors: Charles C. Benedict JR., Katy, TX (US); John W. Crump, IV, Bryan, TX (US); Florence M. Tissot, Corpus Christi, TX (US); James F. Hendrix JR., Houston, TX (US); Christine M. Benedict, Katy, TX (US); Thomas M. Kolaski, Concord, MA (US); Dave Carlson, Houston, TX (US)

Correspondence Address: Robert J. McAughan, Jr., Howrey Simon Arnold & White, LLP, 750 Bering Drive, Houston, TX, 77057, US

(21) Appl. No.: 09/784,935

(22) Filed: Feb. 16, 2001

Related U.S. Application Data
(60) Provisional application No. 60/182,840, filed on Feb. 16, 2000.

(51) Int. Cl. G06F 17/30; G06F 15/163; G06F 9/46; G06F 17/60

(52) U.S. Cl. 707/10; 709/311; 709/328; 705/7

(57) ABSTRACT

An improved database access system is disclosed and claimed. The improved database access system comprises a thin client interface layer, an integration layer, and a data layer made up of a plurality of disparate databases. The integration layer provides consistent interface and finctionality enabling a single thin client interface to serve as a unified access means for numerous databases. Also an improved human resource system utilizing the improved database access system.

### BACKGROUND OF THE INVENTION

At the present time, companies use various database systems to implement various business tasks. Many of these database systems are provided by separate vendors and are not compatible. To access the data from such systems, different user interfaces are required, which fails to provide a consistent look and feel for the data accessed by the user. Moreover, the use of multiple interfaces and databases often results in an inability to associate products, services and databases that could beneficially be combined in a single platform.

FIG. 1 generally illustrates two exemplary prior art database systems, 10 and 16. Each exemplary prior art system includes a user interface that controls the flow of data and information to and from the database where the data is stored. Each databases system includes a user interface layer 11, 17 that contains a rules engine 12, 18 that specifies the data to be retrieved from the database and how it is to be retrieved. For each database the user interface layer and the rules engine combine to control access to the data stored in the database system and to control the format and type of data that may be stored and retrieved from the system.

There are several drawbacks associated with database systems of the type illustrated in FIG. 1. First, because each database 10 and 16 has its own user interface, all access to and from the database must be through the respective user interfaces. There is no clear and ready ability of third party systems or other databases to access the data stored in databases 10 and 16 without passing through and utilizing the user interface layers 11 and 17. This poses problems as the user interfaces of databases 10 and 16 may have different rules engines and require data to be formatted in different ways so that separate, uniquely tailored, access must be made to each database. Moreover, because all access to the databases must be through the user interfaces 11 and 17, the user interfaces 11 and 17 pose a “bottleneck”—requiring all access to pass through the interfaces. This implementation also prevents multiple user interfaces from simultaneously accessing the data in a given database. These limitations of the prior art systems—requiring that data submitted or received from differing databases have a form tailored to that database and requiring access to the databases to pass through a user interface associated with that database—are undesirable in that they do not allow for effective combination of database systems into a composite database access system.

The problems associated with the use of multiple databases are particularly significant in business activities that involve a number of diverse services and activities. For example, business activities associated with the field of human resources often involve employment issues, employee evaluation, employee management, employee handbook issues, retirement issues, compensation issues, and insurance issues. To date there has been no single integrated system that allows for the efficient combination of databases and computer programs relating to such issues into a single, unified—but flexible—platform.

One object of the present invention is to overcome these, and other, deficiencies of the prior art.

### BRIEF SUMMARY OF THE INVENTION

This invention relates generally to database systems. More particularly the present invention relates to an improved system for accessing disparate databases through one consistent user interface. Even more particularly, this invention relates to a computer based system and method for effectively combining, presenting, and allowing access to a variety of databases and computer systems and programs relating to business activities associated with human resources.

### BRIEF DESCRIPTION OF THE SEVERAL VIEWS OF THE DRAWINGS

FIG. 1 is a high level diagram of an exemplary prior art database systems, showing an integrated user interface and rules engine.

FIG. 2 is a high level diagram of one exemplary database access system established in accordance with certain teachings of the present invention, showing a thin client access layer, a integration layer, and a data layer.

FIG. 3 is a more detailed illustration of the exemplary database access system of FIG. 2, showing details of the integration layer.

FIG. 4 is an exemplary logical architecture diagram for the database access system of FIG. 2.

FIG. 5 illustrates a human resources system and tool that may be implemented using certain features of the present invention.

### DESCRIPTION OF ILLUSTRATIVE EMBODIMENTS

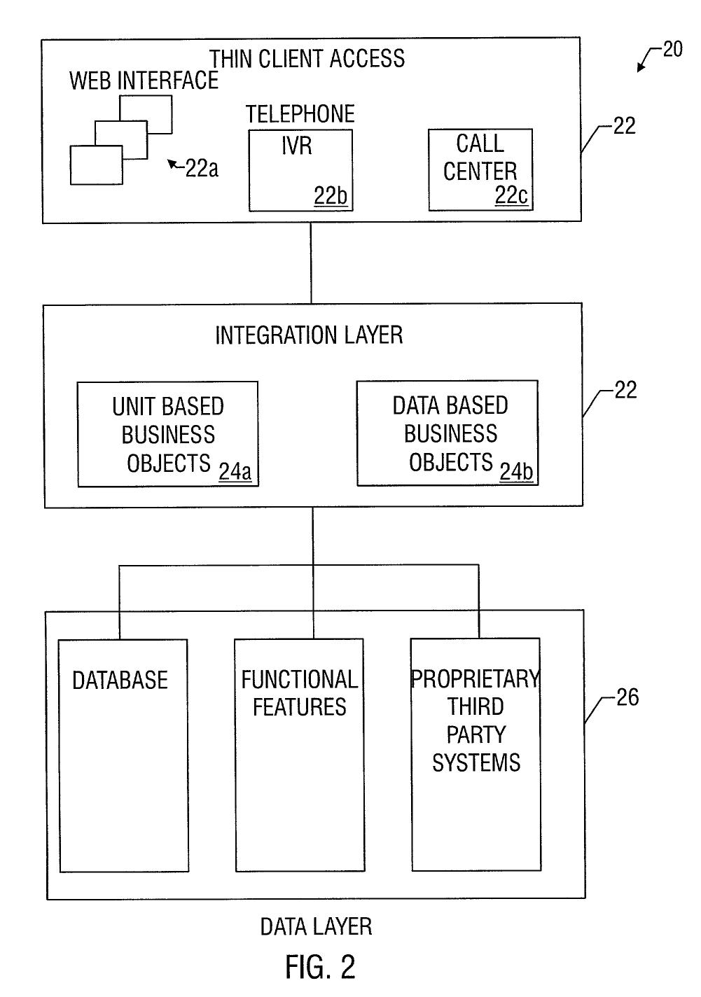

One exemplary database access system 20 constructed in accordance with certain teachings of the present invention is illustrated in FIG. 2. The illustrated system is a computer-based system that provides effective access to a variety of users to a variety of databases and computer systems and support services relating to the field of human resources.

It will be understood that the access system 20 of FIG. 2 is a computer-based system that includes one or more computers (and other hardware as described below and as will be apparent to one of ordinary skill in the art) communicating with each other that are running software to enable the computers to perform the tasks generally described above. The specific construction of the computer software and hardware, and/or the development of software to implement the described functions is not believed to be significant, and variations in the hardware and the software will be possible without departing form the teachings of the present invention.

There are three basic levels to the system 20: a thin client access layer 22; an integration layer 24; and a data layer 26. The thin client access layer 22 communicates with and accesses the intermediate integration layer 24 that includes unit based and data based business objects. The integration layer 24 allows communication between the data layer 26 the thin client access layer 22. The data layer 26 may include databases functional features, and proprietary third party systems. The purpose of the system illustrated in FIG. 2 is to integrate internal and external systems into a single data flow to the user.

The thin client access layer 22 allows individuals and systems access to the system 20. In the illustrated example, the thin client access layer 22 includes a variety of hardware and software systems that allow access to the system in a variety of ways. In the specific illustrated example, the thin client access layer 22 include web based interfaces 22a, a telephone interactive voice response (IVR) system 22b, and a telephone call center manned by live service representatives 22c. Each of these interfaces allows users to access the system in a controlled manner through the provided interfaces.

It will be appreciated that the interfaces described above as 22a, 22b and 22c are exemplary only and that other interface systems may be used. For example, the thin lo client access layer could include systems for allowing access to the system by cell phone, wireless handheld device, or other mobile communicating equipment.

Benefits from the use of the thin client interface layer 24 of the present invention include the ability to have interfaces uniquely tailored to specific users or groups of users. For example, a interface that is designed to receive employee information—e.g., name, address, etc.—can be developed that has graphics, color schemes and asks for information unique to different users of the system. Moreover, because the interface to the databases and systems in the data layer are controlled by the interface layer 24 it is possible to provide differing interfaces to users having access to the same database or systems in the database layer 24.

The interface layer provides thin client access between the interfaces of the thin client access layer and the databases and systems of the data layer 26. Thin client access enables a novel standardized interface for numerous different databases. As described above, commercially available systems that compete with the present invention have a dissimilar architecture that prohibits access to information in third party systems. The unique functionality of the thin client access layer is a reflection of the integration layer 24.

The integration layer 24 may be considered to be a middleware layer that implements features of the improved database access system of the present invention. The exemplary integrating layer 24 of FIG. 2 reconfigures the information passed from the data layer 26 to the thin client access layer 22 and also directs data passage from the data layer 26 to the thin client access layer 22 and vice versa. The exemplary integration layer 26, however, does not re-create functional logic or store the databases that are included in the data layer 26. In the illustrated example, the intermediate layer 24 only provides an interface between the thin client access layer 22 and the data layer 26.

The integration layer 24 of FIG. 2 also includes unit-based business objects 24a and data-based business objects 24b. These business objects provide a means whereby a user accessing the system through the thin client access layer 22 is not encumbered by the database and rule engine programming implemented to retrieve data from differing components in the data layer 26.

The integration layer 24 includes user interface components. These user interface components are basically state identifiers that pass changes down to the database components. The integration layer 24 also includes database components that control what records in the data layer 26 are modified and send the data to the proper location to properly update the database.

The data layer 26 may include databases and functional features that can be part of various proprietary third party systems. The integration layer 24 insures that changes made by the user at the access layer are passed to the proper locations in the data layer 26 and that these changes are updated throughout the system.

Changes made to any of the data layer components by third party applications are implemented throughout the data layer 26 by custom synchronization logic. Custom synchronization logic is developed on a system by system basis as required.

Certain databases included in the data layer 26 may serve as dominant data bases. Dominant databases control the updating of other databases in the data layer 26 and ignore attempts to change themselves by subordinate databases. The feature prevents inconsistent data among the databases.

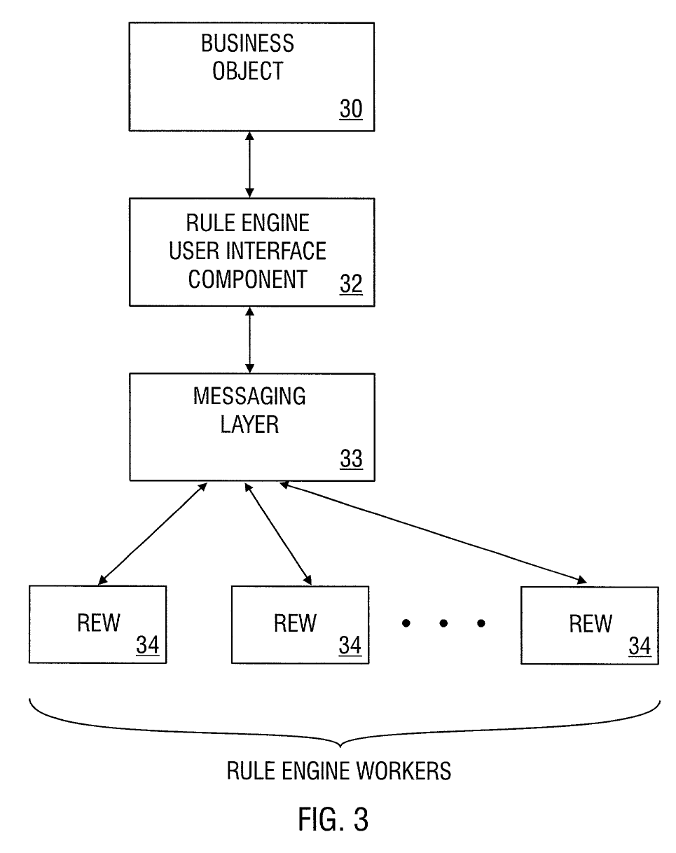

As described above, the integration layer 24 allows the combination of multiple user interfaces provided by the thin client access layer 22 to communicate with a variety of databases and database systems provided by database layer 26. Such communication is enabled through the special structure of the integration layer. One example of a beneficial structure that may be used to construct the integration layer is provided in FIG. 3.

FIG. 3 illustrates components of an exemplary integration layer 24 that includes a business object 30 that interconnects with the a rule engine user interface component 32. The purpose of the business object 30 is to implement some desirable business functionality in a manner transparent to the user of the system. For example, the business object may be associated with the task of keeping track of the current mailing address of an employee. When the business object 30 in the integration layer 24 receives a request from an interface layer client (e.g., a user accessing the integration layer through the thin client access layer 22), it passes this request to the rule engine user interface component 32 associated with that business object. For example, the rules interface component for a business object associated with tracking an employees address may require that the employee address include a zip-code extension, that the address be located within a particular state, that the address include an indication of whether the mailing address is the same as the residence address and may allow a change of address to be made only by a user who can authenticate itself as the employee at issue.

In the illustrated embodiment, when a request is provided to the rule engine user interface component 32, it will then process the request consistent with the request of the rules established for that object (e.g., check the address data for rules violations) and pass the request to a messaging layer 33. The messaging layer 33 will then passes the request to one or more of a plurality of rule engine workers 34.

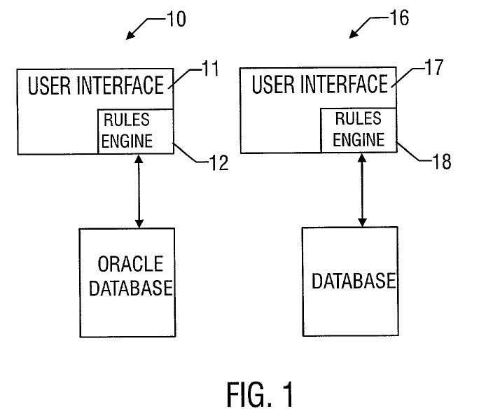

Each of the rule engine workers perform functions similar to the rules engine illustrated in FIG. 1 as part of the user interface, i.e., they communicate data to and from the databases and systems in the data layer 26 in the manner required by the user and the various databases and systems in the data layer 26. The use of multiple rule engine workers 34 allows numerous business objects to request data from numerous databases simultaneously. Any number of rule engine workers may be concurrently implementing requests from any number of business objects, which are representative of any number of users or interfaces. The messaging layer insures that the next available rule engine worker processes the next request, thereby increasing the system speed through parallel operation of the rule engine workers.

One of the benefits of the use of a rules engine interface component 32 and the rules engine workers 34 is that is allows for effective communication between users of the system and the databases and system in the data layer 26. For example, in an illustrated embodiment where the database layer 26 included databases and systems relating to human resources, there would likely be one or more databases that maintain an employees residence and mailing address. Through the use of the system provided above, a business object that was charged with control of the employee's residence address could receive a request—via the thin client access later 22—for a change in the employees residence address. The intermediate layer 26—operating through the systems illustrated in FIG. 3—could then check the address for errors, verify that the person changing the address has the authority to do so, determine if the residence address change requires a change in the mailing address and then, dispatch rules engine workers 34 to each of the databases and systems that would be affected by the chance in the residence address. To the extent that the differing databases had different data format requirements, or different rules engines concerning the form or requirements of the residence address, the business object and its associated systems (e.g., the dispatched rules engine worker 34) would format the data to be acceptable to the system or database of interest.

The system described, therefore, allows a user to communicate and update multiple databases by making only one change though the thin client access layer 22 and the intermediary layer 26. This different from known systems in which a change in the data of one database (e.g., a change in the residence address of a database keeping track of an employee mailing list) would not affect the residence address as stored in a database relating to the employee's insurance file and the change of the address in the various databases would require individual updating of the databases.

The system described in the preceding paragraph and illustrated in FIG. 3 thus decouples the interface layer 22 from the data layer 26, enabling multiple user simultaneous access to the data layer, as well as access by third party clients to the data. The business object illustrated in FIG. 3 provides the means whereby the user is not required to know which databases to query or what queries to issue. The business object implements the specific functionality required by the user's request through the user interface. The rule engine worker calls the specific database required to retrieve the necessary data or functionality.

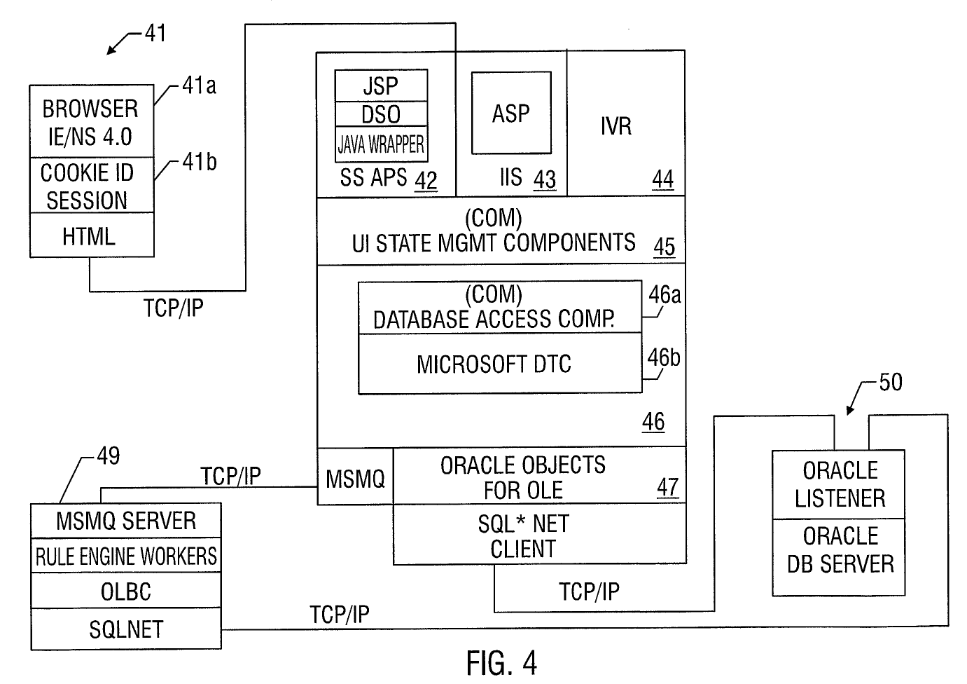

One particularly beneficial use of the database access system described above is to implement a unified human resources administration tool which is described below. The logical architecture that can be used to implement such a system is illustrated in FIG. 4. A brief description of each element in FIG. 4 follows below:

The system of FIG. 4 generally implements the three layer database access system of FIG. 2. In particular, the system of FIG. 4 includes a thin client interface layer 20 that comprises an Internet access unit 41, a web server 42, an Internet information server 43, and a interactive voice response system 45.

The Internet access unit 41 comprises an Internet browser 41 a that allows data communication through a web site. The Internet browser could be any known browser, such as Microsoft Internet Explorer or Netscape Navigator (e.g., 4.0 or higher). In the illustrated example the Internet access unit provides a Cookie ID Session 41b that provides a reference to each client (e.g., system user) session kept via a client side cookie that allows the browser to access state information from one Internet session to another. The Internet access unit 41 communicated using a known transmission protocol such as HTML 3.0. In the illustrated example the Internet access unit communicates through a web server is the transmission protocol between client browser and web server 42 which, in the illustrated embodiment is identified as SS APS and a Silver Stream application server used to present and collect information via HTML.

In the illustrated embodiment the web server 42 includes a number of Java Server Pages (JSP) that contain embedded Java code that cause web server to emit HTML dynamically when a request to view a page has been received.

The web server 42 also provides for a number of Data Source Objects (DSO) which form part of the intermediate layer 24. Data Source Objects are implementations of, for example, the Silver Stream's Data Source Object abstract classes that allow the Silver Stream IDE to interact with custom developed COM components. In essence, DSOs look to the Silver Stream server like a SQL database, when in fact they are talking to COM components.

The web server 42 also includes Java wrappers that are built around user interface COM components that allow server to call methods and properties on the components.

In addition to allowing for communication through the Internet access unit, the exemplary embodiment of FIG. 4 also allows communication to occur through an Internet information server (IIS) 43, such as a Microsoft Internet Information Server that may be used to present and collect information via HTML. In the illustrated embodiment, the Internet information server, provides Active Server Pages (ASP) contain embedded Visual Basic script that cause the Internet Information Server to emit HTML dynamically when a request to view a page has been received.

The illustrated system also allows for access through an Interactive Voice Response (IVR) system 44 allows users to access and perform transactions against data via the telephone. This element could perform the functions of the IVR element 24b of FIG. 2. The IVR 44 may be constructed using known technology.

In the illustrated example the information obtained form and communicated to the components of the thin client access layer 22 described above communicate through an intermediate layer 24 that includes a number of UI State Management Components 45. The UI State Management Components 45 are created components, established by software tuning on a computer system that encapsulate business logic that a user interface developer uses to gain access and perform transactions against data. In the illustrated embodiment, these components conform to the Microsoft Component Object Model (COM) specification. The UI State Management Components 45 provide the rule engine functionality components described above in connection with FIG. 3.

The intermediate layer 24 also includes a transaction server 46 which, in the illustrated example is a Microsoft Transmission Server that is a component and transaction server that dispenses runtime components on a distributed server to remote clients via the DCOM protocol. The transaction server provides Database Access Components 46a that are software-created components that encapsulate business logic that is required to be close to the data store for performance or other reasons. These components conform to the Microsoft Component Object Model (COM) specification. The transaction server also includes a distributed transaction coordinator 46b, which in the illustrated example is a Microsoft Distributed Transaction Coordinator. The distributed transaction coordinator 46b coordinates database transaction across connections and databases. All database access components enlist transaction through the distributed transaction coordinator 46b. The distributed transaction coordinator thus provides the a portion of the functionality of the messaging layer of FIG. 3.

In the illustrated example communication to the database layer 26 occurs through a variety of paths that can include a communications path to a database, or a number of databases in the data layer. In the illustrated example the data layer includes an Oracle database 50 that includes an Oracle listener and an Oracle server that utilizes Oracle DMBS to manage data.

In the illustrated example, communications to the database 50 are made using SQL*NET which is an Oracle protocol used to communicate with Oracle database servers. In the illustrated example, communication through the intermediate layer to the database 50 in the database layer may be made through a first path in which communication occurs through specific communication objects 47, such as Oracle Objects for OLE, that are Object Model components create by Oracle that provide COM interfaces for accessing Oracle database information.

Communication to the database 50 may also occur through a messaging server 49, which in the illustrated example is a Microsoft Message Queue server (MSMQ) that receives, stores, and distributes messages to client applications. The MSMQ server is used to load balance rule engine requests across rule engine worker applications. In the illustrated example, the messaging server 49 controls and dispatches the rule engine worker applications discussed above in connection with FIG. 3. The messaging server 49 provides a messaging client, such as the Microsoft Message Queue client, that is used by database access components to communicate with the MSMQ server. Message queuing is used to create a distributed rules engine server for the application of the system. The messaging server also provides the rule engine workers which, as described above, are created applications that processes rule engine requests from the MSMQ server and executes rules as required to implement the desired system. In the illustrated embodiment, the applications on the messaging server 49 may utilize drivers, such as the Microsoft Open Database Connectivity drivers (ODBC) to communicate with the Oracle database server.

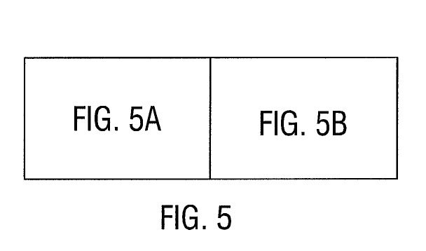

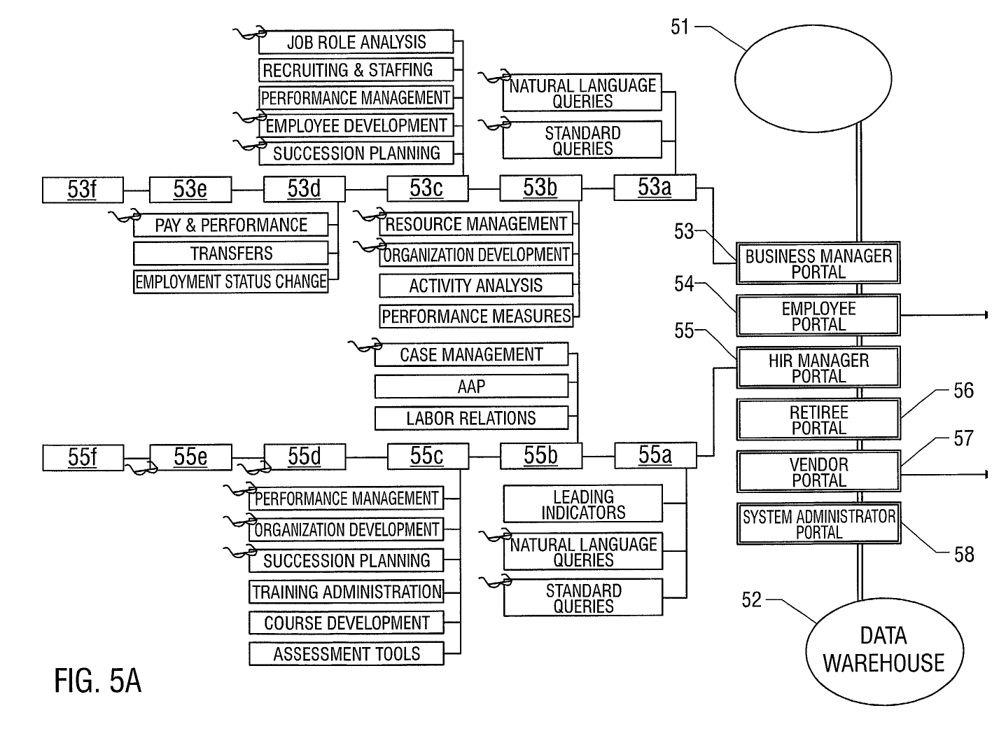

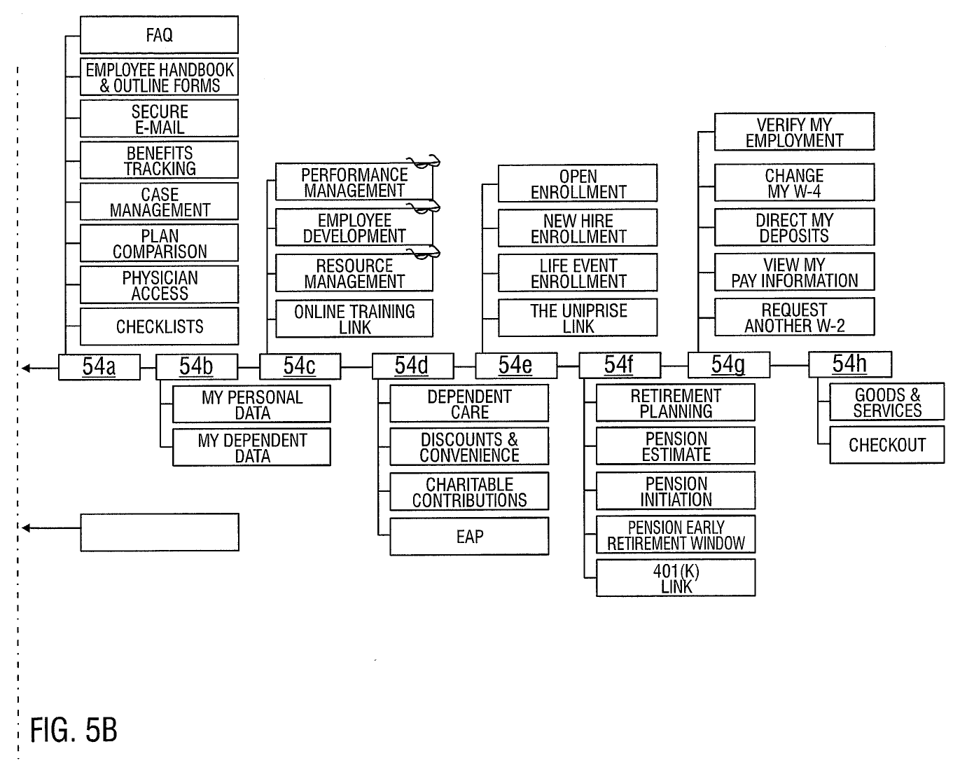

Through use of system components as described in connection with FIG. 4, beneficial, multi-database and multi-systems may be beneficially implemented. One such databases access system is generally illustrated in FIG. 5.

FIG. 5 generally illustrates the type of systems, databases and functionality that may be implement through the use of a system as shown in FIG. 4. Specifically, FIG. 5 shows the overall structure of a human resources tool 50 that provides access to a large number of users to a variety of databases and database systems. The functionality of FIG. 5 is illustrated using the multi-layered database access system as described above in connection with FIGS. 1-4.

Referring to FIG. 5 system 50 constructed in accordance with certain teachings of the present invention for providing human resource services is provided. In general, the system 50 will comprise a number of hardware and software components that implement the multi-layer database access system of FIGS. 1-4 to provide the functionality to be described below. The specific hardware and software components that may be used to implement the system of FIG. 5 may vary from application to application and the selection and/or development of such hardware and software will be within the ability of one of ordinary skill in the art having the benefit of this disclosure.

Referring to FIG. 5, a base 51 is provided that may be a physical location that provides servers and other hardware running software that allows for implementation of the illustrated system. The base 51 may include a service location and assistants and supervisor who can directly operate on the system, field service calls or questions, and provide a mechanism for manual entry of data into the system. In addition to the base 51 and data warehouse 52 is provided. The data warehouse is a physical or logical location where the databases store the data that is used to populate the illustrated system. The data warehouse 52 may be located at the same physical location or at a remote location.

Together the base 51 and the data warehouse 52 provide a system for managing human resource data and systems. In the illustrated example the base 51 and data warehouse operate together to provide a variety of data storage and management functions and other services and functions as described in more detail below. In the illustrated system access to the data and services provided by the system through various portals. Each portal allows individuals having certain characteristics access to data and serves of benefit or interest to that individual.

In the illustrated example, there are six portals: a Business Manager Portal 53, an Employee Portal 54, a HR Manager Portal 55, a Retiree Portal 56, a Vendor Portal 57 and a System Administrator Portal 58. Each portal allows individuals having the appropriate characteristics to enter the system through one of the portals and to access services and data available through that portal and, potential, to change data when an individual access such data to through the portal has the authority to change the same. For example, the Retiree Portal 56 would allow an individual to access the system (through any of the available interfaces provided by the thin client access layer of the system) and, for example check on his or her retirement benefits or obtain information on the company from which he has retired and, potentially, from other retirees who use the system to maintain contact. Also, for example, the System Administrator Portal 58 may allow the system administrator to access various portions of the system and the data on the system for backup archival purposes, for controlling access to various services and data and other common system administrative features. Because the types of data and services that could be provided by the Retiree Portal 56 and System Administrator Portal 58 could vary significantly depending on the particular application of the system provided above, they will not be discussed in detail.

Each of the portals allows access to a plurality of databases and services for those users that the rule engine for the portal determines have access to the databases and services provided by the portal. For example, the Business Manager Portal 53 allows access to the following databases and services: a Data Mining Suite 53a, an Organization Management Suite 53b, an Employee Management Suite 53c, an Employee Administration Suite 53d, a Group Compensation Review Service 53e, and an Organization Chart Service 53f. Many of these databases or services provide additional sub-services that are identified by the text blocks shown in FIG. 5. In a similar manner, the Employee Portal 54 allows access to suitable authenticated employees who are determined to have access to the portal to: a My Resources Service and Database Set 54a, a Me and My Family Service and Database Set 54b, a My Job Life Service and Database Set 54c, a My Home Life Service and Database Set 54d, a Health and Welfare Suite 54e, a Retirement Suite 54f, a Payroll Information Suite 54g, and a Grocery Store Suite 54h. Like the services and databases available through the business Manager Portal 53, the services and databases provided through the Employee Portal 54 include sub-services and sub-databases as set forth in the text blocks of FIG. 5. In the exemplary embodiment of FIG. 5, the HR Manager Portal 55 provides access to a Data Mining Suite 55a, a Compliance Suite 55b, an Organization Training and Development Suite 55c, a Pay and Performance Service and Database Set 55d, and a Recruiting and Staffing Service and Database Set 55e, and a Project Online Service 55f. In the illustrated example, the Vendor Portal 57 provides access to a Project Online Service 57a, and the

A general description of the functionality of each portal and the data and services (and sub-data bases and sub-services) that may be accessed through the same is provided below.

It should be noted that the above description of several exemplary embodiments, and the following discussion of the portals of FIG. 5, is made by way of example and not for purposes of limitation. Many variations may be made to the embodiments and methods disclosed herein without departing from the scope and spirit of the present invention. The present invention is intended to be limited only by the scope and spirit of the following claims.

What is claimed is:

1. A system for accessing a plurality of databases comprising:
a thin client interface layer that receives data through at least one user-accessible interface; and
an intermediate layer that receives the data from the thin client interface layer and provides the data to one or more of the databases that:
checks the data to determine which databases need access to the received data;
formats the data for each database that needs to have access to the received data; and
communicates the formatted data to each database that needs to have access to the received data.

2. The system of claim 1 wherein the in which the user-accessible interface comprises an Internet web browser.

3. The system of claim 1 wherein the intermediate layer comprises a business object that implements a desired functionality; a rules engine that checks the received data against a set of predetermined rules for such data; and a messaging layer that communicates the data to the databases that need access to the received data via a rules engine that formats the data for a database associated with the rules engine.

4. A system for providing human resource services comprising:
at least one user interface that allows a user to access plurality of human resource related databases via a plurality of portals, each portal providing the user with access to a collection of databases; and
an intermediate layer that receives input from the user interface, checks the input against a rules engine, and provides the input to a plurality of databases in which the received input is stored, such that the input need only be entered once at the user interface to be stored in the plurality of databases.
